(19) United States
(12) Patent Application Publication
(10) Pub. No.: US 2013/0161407 A1
(43) Pub. Date: Jun. 27, 2013

(54) DEVICE AND METHOD FOR NEBULISING OR ATOMISING FREE-FLOWING MEDIA

(71) Applicants: Harald Hielscher, Stahnsdorf (DE); Thomas Hielscher, Stahnsdorf (DE); Holger Hielscher, Teltow (DE); Ingo Jaenisch, Ahrensfelde (DE)

(72) Inventors: Harald Hielscher, Stahnsdorf (DE); Thomas Hielscher, Stahnsdorf (DE); Holger Hielscher, Teltow (DE); Ingo Jaenisch, Ahrensfelde (DE)

(73) Assignee: DR HIELSCHER GMBH, TELTOW (DE)

(21) Appl. No.: 13/820,524

(22) PCT Filed: Sep. 1, 2011
(86) PCT No.: PCT/EP11/65147

§ 371 Date: Mar. 4, 2013

Related U.S. Application Data
(60) Provisional application No. 61/379,422, filed on Sep. 2, 2010.

(51) Int. Cl. B05B 17/06

(52) U.S. Cl. CPC B05B 17/06
USPC 239/4; 239/102.1

(57) ABSTRACT

The invention relates to a device and a method for nebulizing flowable media by means of low-frequency high-energy ultrasound. According to the invention, the device comprises an ultrasound system (2) and at least one carrier element (1) that is positioned near or in direct contact with at least one part of the oscillating surface of the ultrasound system (2), the flowable medium (3) being fed to the ultrasound region by the carrier element (1).

The invention relates to an apparatus and a method for nebulizing flowable media by means of low-frequency high-power ultrasound (NFLUS).

Low-frequency high-power ultrasound (NFLUS) is ultrasound with an operating frequency of 15 to 2000 kHz, preferably 15 to 800 kHz, for example, 30 kHz, and acoustic power greater than 5 W, preferably 50 W to 2000 W, for example 200 W. For example, a piezoelectric or magnetostrictive systems can be used for generating the ultrasound. Linear transducers and flat or curved plate oscillators or tubular resonators are known. Low-frequency high-power ultrasound finds a wide application in nebulizing flowable media, such as dispersions, solvents, water, oils, emulsions, melts, acids, bases and other liquids. For this purpose, ultrasound with amplitudes of 1 to 350 μm, preferably 10 to 80 micrometers, for example 65 μm are transferred from an ultrasound system to the flowable medium.

For nebulizing, a flowable medium broad into proximity to a surface of the ultrasound system vibrating with NFLUS. This can be done at any angle, for example, from the front or through the ultrasound system. Due to the acceleration experienced by the flowable medium upon impact on the oscillating surface, the medium is broken up into smaller droplets or particles (hereinafter summarily referred to as particles). Higher frequencies fundamentally generate, smaller particles. Particles sizes from 0.1 to 2.0 μm can be produced with frequencies from 800 to 2000 kHz. However, such systems are limited in their volume throughput. Lower frequencies, e.g. between 20 and 100 kHz, fundamentally allow a higher volume throughput. However, these systems generate relatively larger particles, for example in the range of 5 to 100 μm.

Lambda is the wavelength resulting from the NFLUS frequency and the sound propagation velocity in the resonator. A resonator may be composed of one or more Lambda/2-elements. A resonator composed of a plurality of Lambda/2-elements may be manufactured from a single piece of material having an appropriate length or can be assembled from a plurality of elements of length n*Lambda/2 (n ε N), for example, by screwing. Lambda/2-elements may have various material cross-sectional geometries, such as circular, oval or rectangular cross-sections. The cross-sectional geometry and cross-sectional area may vary along the longitudinal axis of a Lambda/2-element. Lambda/2-elements may also be made of metallic or ceramic materials or glass, in particular of titanium, titanium alloys, steel or steel alloys, aluminum or aluminum alloys, for example of titanium grade 5.

An ultrasonic system is composed of at least one ultrasound transducer, e.g. of a piezo-ceramic/piezoelectric transducer, in conjunction with any number of resonators.

In addition to atomizing in an atmospheric environment, flowable media may also be atomized in a non-atmospheric environment, for example in sealed containers, such as reactors or drying towers, at pressures different from ambient atmospheric pressure, e.g. at a lower pressure, in a vacuum, or under increased pressures and in the presence of specific ambient gases, for example argon or other inert gases or in particular under dry or humid conditions.

A lower pressure (reduced pressure) is between vacuum (0 bar absolute) and ambient pressure (e.g. 1 bar absolute), e.g. at 0.5 bar. A higher pressure (positive pressure) is present when the pressure is above the ambient pressure. Some systems use an internal container pressure between 1.5 bar absolute to 100 bar absolute, for example 3 bar absolute.

To introduce NFLUS into such vessel, either the vessel wall is set into vibrations by an externally mounted NFLUS system or an NFLUS transducer be completely incorporated in the pressurized vessel interior. Alternatively, the transducer, for example a piezoelectric linear transducer, may be disposed outside of the vessel and the vibrations can be introduced into the vessel interior by one or more resonators. Due to the pressure difference between the internal vessel pressure p (i) and the ambient pressure p (a), it is necessary in this case to take appropriate measures to seal the entry point of the resonator(s).

It is the object of the invention to provide a apparatus and a method with which flowable media can be more effectively nebulized when using NFLUS.

This object is attained according to the invention by the features of the claims 1 and 11. Advantageous embodiments are recited in the dependent claims.

According to the invention, an apparatus and a method for nebulizing or atomizing flowable media with an ultrasound system and with at least one carrier element it is provided, wherein this carrier element is positioned close to or in direct contact with at least a portion of the oscillating surface of the ultrasound system.

The carrier element is preferably a substantially two-dimensionally designed component which may optionally be deformable into three dimensions.

Experiments have shown that when ultrasound is applied to a flowable medium, which is exposed to the ultrasound on or in a carrier element, this medium can be very efficiently nebulized or atomized. Depending on the respective oscillation amplitude and/or oscillation frequency, and depending on the properties and tension of the carrier element as well as of the flowable medium and the distance between the ultrasound system and the carrier element, the ultrasound oscillations are transmitted to the carrier element, so that the carrier element oscillates with approximately the same frequency, or the carrier element remains substantially stationary, and flowable medium coming in contact with the carrier element is oscillated and thereby nebulized or atomized. In other words, droplets of the flowable medium having a very small diameter can be produced with the inventive device in a simple and efficient manner, which are flung into the vicinity of the carrier element due to the oscillation-induced accelerations.

The apparatus of the invention is here designed for a throughput of at least 0.5 liter of medium to be nebulized or atomized. For this purpose, the apparatus may include a fluid feed or feed device capable of feeding at least 0.5 liter of the flowable medium to the ultrasound region.

Preferably, the carrier element is a tape. This means that the carrier element is preferably a substantially two-dimensional shaped element, whose longitudinal extension is substantially greater than its transverse extension.

Alternatively, the carrier element may also have a circular or annular shape capable of supplying flowable medium into the ultrasound region with a rotational movement.

The carrier element is constructed to receive on at least one of its sides a flowable medium and/or absorb flowable medium. The flowable medium can thus be received on a lateral surface due to gravity and/or cohesion or adhesion, and the absorption in the material of the carrier element may, for example, be affected by capillary forces.

The advantageous embodiments of the invention mentioned below relate to both the apparatus of the invention and the method of the invention.

By using the carrier element, in particular in form of a tape, the attainable particle size, particle size distribution, the potential volume flow rate or several of the aforementioned variables can be affected.

Preferably, the ultrasound system should oscillate with a frequency between 15 and 2000 kHz, in particular between 15 and 800 kHz, and in a particularly preferred embodiment between 15 and 150 kHz.

The ultrasound system is designed for the transmission of ultrasound having an amplitude from 1 to 350 μm, in particular for an amplitude from 10 to 80 μm.

Furthermore, the ultrasound system is designed for transmitting ultrasound with a power of more than 5 Watt, in particular for a power between 50 and 2000 Watt, and in a particularly preferred embodiment for a power between 50 and 500 Watt.

The carrier element may abut the ultrasound system surface. The carrier element may hereby be urged, pressed or pulled against the surface of the ultrasound system. More than one carrier element can be employed.

A piezoelectric exciter or a magnetostrictive transducer may be used for generating ultrasound.

The inventive method for nebulizing or atomizing of flowable media is performed by using the apparatus of the invention, wherein ultrasound from the ultrasound system is directed towards the flowable medium which is in contact with the carrier element.

This contact is preferably a direct contact, such as when the flowable medium adheres to the carrier element, or when the flowable medium is received by or absorbed by the carrier element. This means that the flowable medium is in contact with the carrier element at least or in particular in or on the region of the carrier element that is directly exposed to ultrasound.

The flowable medium may be arranged on one side of the carrier element so that the carrier element is positioned between the flowable medium and the oscillating surface of the ultrasonic system.

Alternatively, the flowable medium may be arranged on both sides of the carrier element. This means that a first layer of the flowable medium is arranged between the ultrasound system and the carrier element, and a second layer of the flowable medium is arranged on the side of the carrier element opposite the first layer.

The flowable medium may be fed to the ultrasound region via the carrier element, or the flowable medium may be fed with the ultrasound system.

The ultrasound system may have longitudinal oscillations and/or radial oscillations and/or bending oscillations on the surface facing the carrier element. This means that the ultrasound system can exhibit complex oscillatory movements on the surface facing the carrier element.

Water, a dispersion, a solvent, an acid, a base or a melt may be used as a flowable medium.

The flowable medium is fed via the support element or with the ultrasound system.

The flowable medium may be fed via more than one feed, for example via at least one slit-shaped feed.

The volume flow of the feed of the flowable medium may be from 0.01 to 1000 ml per second, and in particular from 0.1 to 100 ml per second.

The flowable medium may be fed with a variable volume flow rate, which allows affecting the particle size, particle size distribution and the volume flow rate.

The method should be performed such that the diameter of more than 50 percent of the generated particles is between 0.01 to 500 μm (peak—peak), in particular from 0.5 to 100 μm, and in a preferred embodiment between 0.5 and 10 μm (peak—peak), for example smaller than 2 μm.

The carrier element can be made of metal or a metal alloy, planned fibers or animal fibers, carbon fibers, or polymers, a composite material or a fabric.

In particular, the carrier element may have a plurality of through holes. Here, the carrier element may be perforated. The carrier element may have a thickness between 0.01 and 10 mm, in particular between 0.1 and 1 mm.

The carrier element is preferably a flexible material and can be composed of various materials, preferably of a not completely closed material, for example of a fabric or a perforated foil. The carrier element may be made of different materials, among other metals, metal alloys, glass, plastics, paper, carbon fibers, wool, plant fibers, or cotton, or a combination of different materials. The carrier element may have several openings or recesses, e.g. pores, channels or tissue interstices. The material of the carrier element may repel fluids, for example, by using Teflon or lotus-effect coating, or may attract fluids, e.g. hydrophilic as a result of nano-coatings. The thickness of the carrier element may vary across the carrier element. The carrier element may be curved or spatially deformed at least over its length or width. Specifically, the carrier element may be formed as a tape.

The inventive process may be carried out in a closed system. The system pressure may be adjusted higher or lower than the atmospheric pressure.

The part of the surface of the ultrasound system, in relation to which the carrier element is positioned close to or in direct contact can have a surface area between 0 and 500 cm^{2,} in particular between 0 and 50 cm², and in a particularly preferred embodiment between 1 and 5 cm²

The position, thickness or properties of the carrier element may be varied during the process, in particular for affecting the particle size, particle size distribution, or the volume flow rate.

Furthermore, the carrier element may be moved, and/or the generated particles may be moved by a flow, preferably horizontally or vertically.

With the inventive combination of a s NFLUS ultrasound system with at least one carrier element, it is possible to influence the particle size, the particle size distribution, the volume flow rate or several of the aforementioned quantities. It is also possible to increase the volume flow rate while simultaneously reducing the particle size by using a predetermined ultrasound system.

The carrier element is positioned close to or in direct contact with at least a portion of the oscillating surface of the ultrasonic system. The distance between the carrier element and the surface of the ultrasound system can be between 0 and 100 mm, preferably between 0 and 1 mm, for example 0.5 mm.

If the carrier element directly contacts the ultrasound system, the carrier element may additionally be urged against, pressed against, or pulled against, for example, pulled against the ultrasound system.

The part of the surface of the ultrasound system, in relation to which the carrier element is positioned in close proximity or in direct contact, may be flat, or may in at least one direction be concave, convex, rounded, beveled, chamfered or have a polymorph design.

The thickness of the carrier element may be, for example, between 0.01 and 10 mm, preferably between 0.05 and 1 mm, for example 0.5 mm. The width and length of the carrier element may be selected independently of each other so that the carrier element partially or completely covers the surface of the ultrasound system, or protrudes over the surface.

The part of the ultrasound system surface, in relation to which the carrier element is positioned in close proximity or in direct contact, may preferably between 0 and 500 cm², for example, 5 cm², and may vary during the process.

The position, shape, thickness or the contact pressure of the carrier element may vary during the process, for example, to affect the particle size. The part of the carrier element, which is positioned close to or in direct contact with the surface of the ultrasound system, may vary. For example, a continuous movement of the carrier element relative to the ultrasound system is possible. This movement may be used, inter alia, to compensate for wear on the carrier element, to remove incrustations or contamination, or to affect the particle size and the particle size distribution.

The flowable medium may be supplied to at least one arbitrarily selected side of the carrier element, to or through the ultrasound system or to the space between the carrier element and the surface of the ultrasound system. The carrier element may also be moistened or impregnated for purpose of feeding the fluid.

The above possible embodiments can be combined as desired.

The invention will be further explained in more detail with reference to several exemplary embodiments.

The appended drawings show in

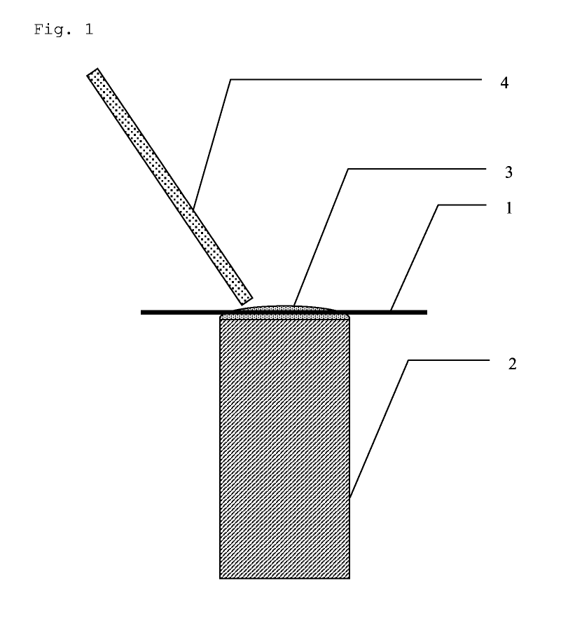

FIG. 1 an embodiment of an apparatus according to the present invention. The tape (1) is located in direct proximity to a portion of the surface of the ultrasound system (2), the fluid (3) is fed via the liquid feed (4).arranged above the tape (1).

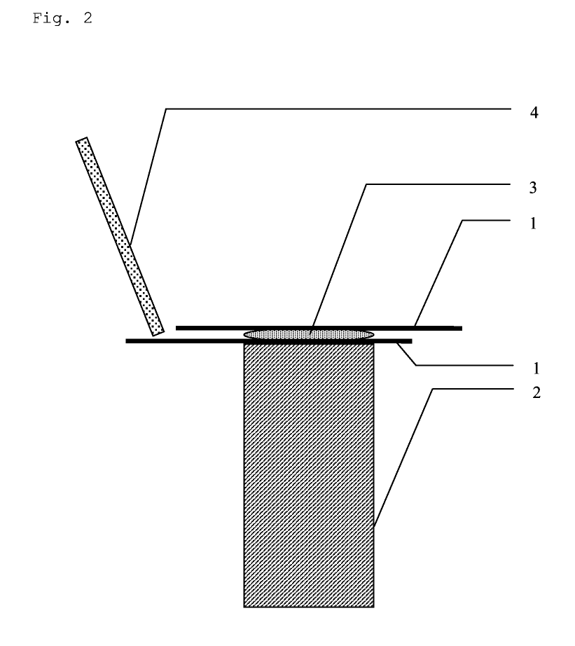

FIG. 2 a similar variant as in FIG. 1, however with two tapes (1), between which the fluid (3) is fed via the liquid feed (4).

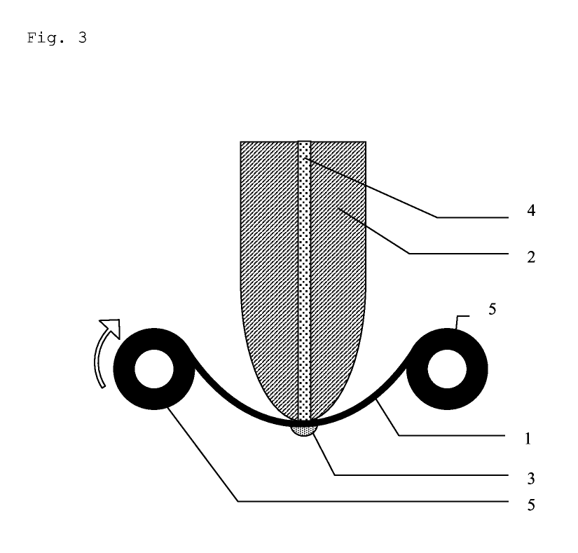

FIG. 3 a similar variant as in FIG. 1, however the ultrasound system (2) is located above the tape (1). The liquid feed (4) is performed by the ultrasound system (2). The ultrasound system has a curved surface with which the tape (1) is in direct contact. The tape (1) is pulled against the ultrasound system by the unwinding and winding device (5) and is moved continuously.

The inventive combination of a NFLUS ultrasound system with at least one tape makes it possible to affect the particle size, particle size distribution, the volume flow rate or several of the aforementioned quantities. All variants have in common that the tape is positioned in close proximity or in direct contact with at least a portion of the vibrating surface of the ultrasound system in order to nebulize the supplied fluid.

FIG. 1 shows a rotationally symmetric ultrasound system (2), which is composed, for example, of a resonator and an ultrasound transducer. This means that the apparatus according to the invention includes a resonant system.

The resonator was made, for example, of titanium grade 5 and has a diameter of e.g. 40 mm. The ultrasound transducer operates piezoelectrically. The surface on which the tape was positioned oscillates with an operating frequency from 15 to 100 kHz, preferably 15-30 kHz, e.g. 30 kHz, and with an acoustic power of 10 to 2000 Watt, preferably 50 to 100 Watt, for example with 250 Watt, and an amplitude of 0 to 500 μm, preferably from 10 to 300 μm, e.g. 75 μm. The fluid (4) is, for example, an oil, and is fed at 20 ml/sec and 20° C. The tape (1) is made, for example, of a wire mesh. The individual wires having a diameter of 0.1 mm and a spacing of, for example, 0.1 mm.

A similar embodiment is illustrated in FIG. 2, wherein the flowable medium is disposed between two tapes 1.

The particular feature of the embodiment illustrated in FIG. 3 is that the flowable medium penetrates the tape, which may for this purpose have pores or a lattice structure.

### LIST OF REFERENCE NUMERALS

1 Tape

2 Ultrasound System

3 Fluid

4 Fluid feed

5 Unwinding and winding device

1-20. (canceled)

21. An apparatus for nebulizing or atomizing a flowable medium, comprising:
an ultrasound system having an oscillating surface; and
at least one carrier element positioned close to or in direct contact with at least a portion of the oscillating surface.

22. The apparatus of claim 21, wherein the carrier element comprises a tape.

23. The apparatus of claim 22, wherein the carrier element has at least two sides and is configured to receive or absorb, or both, the flowable medium on at least one of the sides.

24. The apparatus of claim 21, wherein the ultrasound system is configured to oscillate with a frequency between 15 and 2000 kHz.

25. The apparatus of claim 21, wherein the ultrasound system is configured to transmit ultrasound with an amplitude between 1 to 350 μm.

26. The apparatus of claim 21, wherein the ultrasound system is configured to transmit ultrasound with a power of more than 5 Watt.

27. The apparatus of claim 21, wherein a distance between the carrier element and the surface of the ultrasound system is between 0 and 100 mm.

28. The apparatus of claim 21, wherein the carrier element is urged against, pressed against or pulled against the surface of the ultrasound system.

29. The apparatus of claim 21, wherein the carrier element comprises a metal or a metal alloy.

30. The apparatus of claim 21, wherein the carrier element comprises a plurality of through-openings.

31. A method for nebulizing or atomizing a flowable medium with an apparatus having an ultrasound system with an oscillating surface and at least one carrier element positioned close to or in direct contact with at least a portion of the oscillating surface, the method comprising:
bringing the flowable medium in contact with the at least one carrier element; and
directing ultrasound generated with the ultrasound system onto the flowable medium.

32. The method of claim 31, wherein the at least one carrier element is positioned between the flowable medium and the oscillating surface of the ultrasound system, and wherein the flowable medium is disposed on one side of the at least one carrier element.

33. The method of claim 31, wherein the flowable medium is disposed on at least two sides of the at least one carrier element.

34. The method of claim 31, wherein the oscillating surface faces the at least one carrier element and performs at least one of:
a) longitudinal oscillations;
b) radial oscillations; and
c) bending oscillations.

35. The method of claim 31, wherein the flowable medium is at least one substance selected from water, a dispersion, a solvent, an acid, a base, and a melt.

36. The method of claim 31, wherein the flowable medium is fed;
a) via the at least one carrier element; or
b) by the ultrasound system.

37. The method of claim 36, wherein the flowable medium is fed with a volume flow that is varied in order to affect at least one of particle size, particle size distribution and the volume flow rate.

38. The method of claim 31, wherein a position, thickness or physical property of the at least one carrier element is varied in order to affect at least one of particle size, particle size distribution and the volume flow rate.

39. The method of claim 31, wherein the at least one carrier element is moved in relation to the ultrasound system.

40. The method of claim 31, wherein particles generated by nebulizing or atomizing are moved by an external flow.
